(19) United States
(12) Patent Application Publication
(10) Pub. No.: US 2019/0286087 A1
(43) Pub. Date: Sep. 19, 2019

(54) Method and Apparatus for Realization of an Interactive Smart Structure

(71) Applicant: Bridgewest Ventures LLC, San Diego, CA (US)

(72) Inventor: Saeid Safavi, San Diego, CA (US)

(21) Appl. No.: 16/355,269

(22) Filed: Mar. 15, 2019

Related U.S. Application Data
(60) Provisional application No. 62/643,350, filed on Mar. 15, 2018.

(51) Int. Cl. G05B 19/042; G06N 5/02

(52) U.S. Cl. CPC G05B 19/042; G05B 2219/25011; G06N 5/02

(57) ABSTRACT

A next generation system for use in a “smart” structure, such as a building and/or home, has been described. The disclosed method and apparatus allows the system to not only act on the commands received from the employees/occupants, but also to create a natural and meaningful interaction between the system and the users. An interactive environment such as is disclosed can benefit from a high level of awareness that can be enhanced through the collection of various bits of information. Such information may be collected by coupling various sensors and devices to obtain data. Such data collection can be performed by consistent monitoring of the state of the user and the surrounding environment.

### CROSS-REFERENCE TO RELATED APPLICATIONS—CLAIM OR PRIORITY

The present application claims priority to U.S. Provisional Application No. 62/643,350, filed on Mar. 15, 2018, entitled “Method and Apparatus for Realization of an Interactive Smart Building”, which is herein incorporated by reference in its entirety.

### BACKGROUND

### (1) Technical Field

Systems and methods for controlling a smart home, office or other structure or occupied environment.

### (2) Background

Currently “smart” homes, offices and other such occupied environments allow an occupant to provide voice commands to control various devices, systems and functions within the environment. For example, Google provides a system they call “Alexa” that can be paired on a WiFi or Bluetooth network to connect to devices within an environment, such as in a person's home, to control lights, thermostat, television, etc. As people begin to integrate these types of smart home systems into their routines, there are likely to be improvements that would be beneficial to such systems. Accordingly, there is already a need for improved smart environment systems that can perform even more functions and do so in a “smarter” way.

### DESCRIPTION OF THE DRAWINGS

FIG. 1 is an illustrated of an analytics platform for a context aware smart home in accordance with one embodiment of the disclosed method and apparatus.

FIG. 2 is an illustration of an analytics solutions platform.

FIG. 3 is an illustration of one embodiment of a Cross-Layer Parameter Collection & Network Topology Detection system that may be used in the disclosed method and apparatus to collect data.

FIG. 4 is an illustration of a High Level Platform Architecture that can be used to implement the system of the disclosed method and apparatus.

FIG. 5 is an illustration of the process flow for determining a QoE model.

Like reference numbers and designations in the various drawings indicate like elements.

### DETAILED DESCRIPTION

The presently disclosed method and apparatus provides a next generation system for use in a “smart” structure, such as a building and/or a home. The disclosed method and apparatus allows the system to not only act on the commands received from the employees/occupants, but also to create a natural and meaningful interaction between the system and the users. An interactive environment such as is disclosed can benefit from a high level of awareness that can be enhanced through the collection of various bits of information. Such information may be collected by coupling various sensors and devices to obtain data. Such data collection can be performed by consistent monitoring of the state of the user and the surrounding environment. For example, the location of the user within the environment can be monitored. In addition, the amount of time the user spends in each location within the environment can be monitored and maintained.

By using the sensory information collected to determine particular habits and patterns of behavior, the disclosed method and apparatus is able to determine the current user's preferences and requirements. Accordingly, the system can make suitable adjustments to support an ongoing comfortable, safe and efficient environment for the user and others that enter the environment.

Providing a thinking smart home creates an environment that can be customized to each particular occupant and/or particular combination of occupants. This creates a customized, real-time, quality of experience (QoE) model that can be based on the existing context. In addition, in some embodiments, such a customization can use historical data to determine a user's comfort and satisfaction level. Accordingly, the system can adjust various control devices and actuators to maximize the comfort and level of satisfaction for each person within the system environment. In accordance with some embodiments, the resulting QoE model will be able to predict and provide user satisfaction by processing of the user related data along with the environmental data in a proactive way. Data that is attained both from actively monitoring the environment and by inferring additional data (extrapolating, etc.) and using the data derived from both monitoring and inferring in parallel, the QoE model can be significantly enhanced.

In some embodiments, the system is coupled to a device, such as one of today's smart mobile devices. Such devices may be equipped with various sensing mechanisms. Accordingly, with the appropriate software tool installed, these devices can measure different biological and activity and state parameters associated with the user. These may include parameters such as the user's heart rate and body temperature. In some embodiments, the system can also capture the facial expression (such as through post processing camera images on a smart phone). Additional environmental parameters, such as the humidity and temperature of each room within the environment, the time, and the user location can also be monitored, maintained and processed together with other information to assist in controlling the environment.

In some embodiments, the data that is collected and derived from various means, including data that has been determined as a consequence of analytic processing of monitored data, can be scaled and/or pruned to place the data into various contextual data forms that can be directly applied to a machine learning-based user action prediction model. The data may also be provided to a related QoE estimation module that can use these gathered and processed sensory data along with historical user decision data to infer user preferences. This can then lead to a decision for each smart home application scenario.

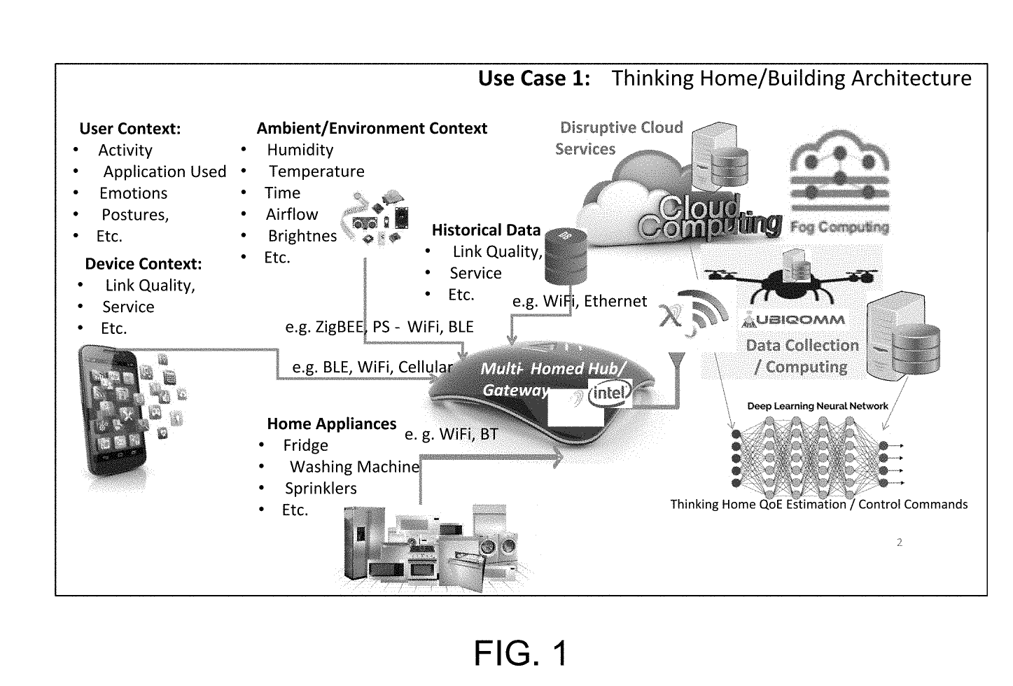

FIG. 1 is an illustrated of an analytics platform for a context aware smart home in accordance with one embodiment of the disclosed method and apparatus. The QoE model is based on collection of various contextual data customized to each occupant or user. In some embodiments, such data may include user physical signs (e.g., gestures, pulse, temperature, facial expressions, etc.), which can be directly extracted by sensors on a mobile device. In some embodiments, other user devices can be used either instead or in addition to such mobile devices. In addition, some embodiments include environment sensors. In some embodiments, the data may be collected or enhanced by an application that the user runs on the device, user interest topics, as well as, the user activities detected by the device or another sensor. Such activities may include things such as sitting, walking, or resting.

Other contextual information, such as (1) device and network related data; (2) the service “meta data” (if the user is using a web-based service), (3) QoS parameters; and (4) environmental sensor data may also be collected and pre-processed. In addition, historical data (in some embodiments, categorized by a level of important) can be captured and analyzed. Such data may include the user's previous decisions, based on previous collected context. Such data may be incorporated into the QoE model. Through an application of a Machine Learning architecture, such as deep neural networks, the QoE model estimates the user QoE. The user QoE may be represented in various forms, such as: (1) binary classification, (2) multi-class classification (using a MOS or mean-opinion-score); or (3) a regression based parametrization. Such QoE models may be computed and compared it to a target QoE per user. If there is no match, the context along with the level of estimated QoE are processed and decisions are made on the proper corrective action for the scenario. After the appropriate action is performed the user QoE is revaluated in a feedback based mechanism in order to enhance the user level of happiness, comfort, and/or satisfaction.

Examples of network analytics frameworks based on machine learning include:

(1) Scalable data collection and real-time streaming analytics;

(2) Massive parallel processing and storage;

(3) Data retrieval and processing;

(4) Analytics engine and business intelligence; and

(5) Domain-specific analytics solutions.

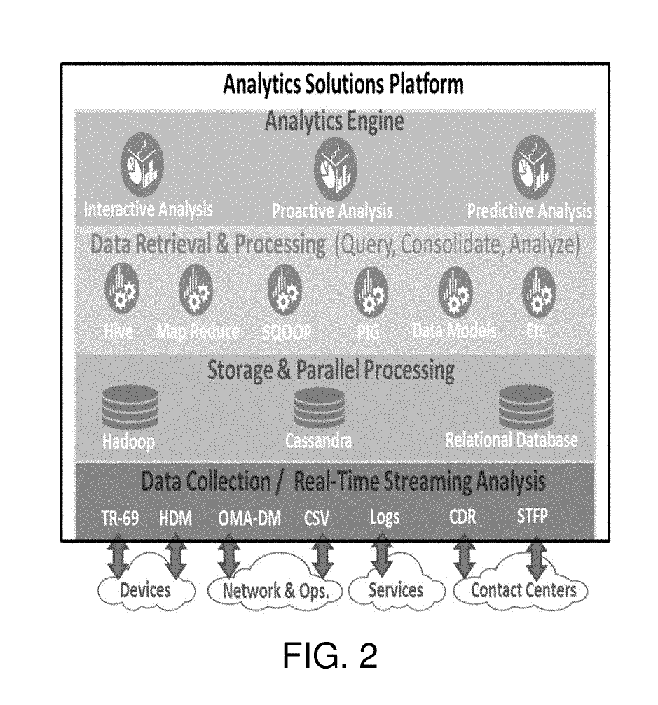

FIG. 2 is an illustration of an analytics solutions platform.

Scalable data collection and real-time streaming analytics allows operators to collect and store any data, as often as they need. TR-069 (Technical Report 069) is a technical specification of the Broadband Forum that defines an application layer protocol for remote management of customer-premises equipment (CPE) connected to an Internet Protocol (IP) network. TR-069 and streaming video QoE clients can be used to collect data from devices. The video can be analyzed using image recognition to detect features and derive data for use by the processing engine of the QoE estimation module. In some embodiments, data is collected about network operations, services, and call center interactions using, for example, Comma separated Value (CSV) files, logs, CDRs, and SFTP. A CSV is a comma separated values file that allows data to be saved in a table structured format. CSVs look like garden-variety spreadsheets. However, CVS files have a “.csv extension”. Traditionally they take the form of a text file containing information separated by commas, hence the name. A CDR is a file extension for a vector graphics file used by Corel Draw, a popular graphics design program. Corel Paint Shop Pro and Adobe illustrator 9 and later can also open some CDR files. FTP, or “File Transfer Protocol” is a popular method of transferring files between two remote systems. SFTP, which stands for SSH (Secure Shell) File Transfer Protocol, or Secure File Transfer Protocol, is a separate protocol packaged with SSH that works in a similar way over a secure connection.

Massive parallel processing and storage uses HADOOP for big data storage and batch processing, CASSANDRA for real-time data analytics (for example, for real-time customer support), and relational database for data storage for reports and dashboard tools. HADOOP is an open source, Java-based programming framework that supports the processing and storage of extremely large data sets in a distributed computing environment. It is part of the Apache project sponsored by the Apache Software Foundation. Apache CASSANDRA is a free and open-source distributed NoSQL database management system designed to handle large amounts of data across many commodity servers, providing high availability with no single point of failure. A NoSQL (originally referring to “non SQL” or “non relational”) database provides a mechanism for storage and retrieval of data that is modeled in means other than the tabular relations used in relational databases.

Data retrieval and processing can be used that is built on top of HADOOP, and is used for data querying and analysis—using data processing frameworks and tools, such as HIVE (a key component of the HADOOP ecosystem, MapReduce, and SQOOP. SQOOP supports incremental loads of a single table or a free form SQL query as well as saved jobs which can be run multiple times to import updates made to a database since the last import. Imports can also be used to populate tables in Hive or HBase.

Analytics engine and business intelligence consolidates, correlates, and analyzes data for automated actions or human interpretation. This includes filtering and normalization of raw data, and mapping of the data to particular Key Performance Indicators (KPIs) and use case templates.

Domain-specific analytics solutions allow operators to organize the resulting analytics events and alerts into particular business needs, such as home device analytics, online video analytics, or security analytics.

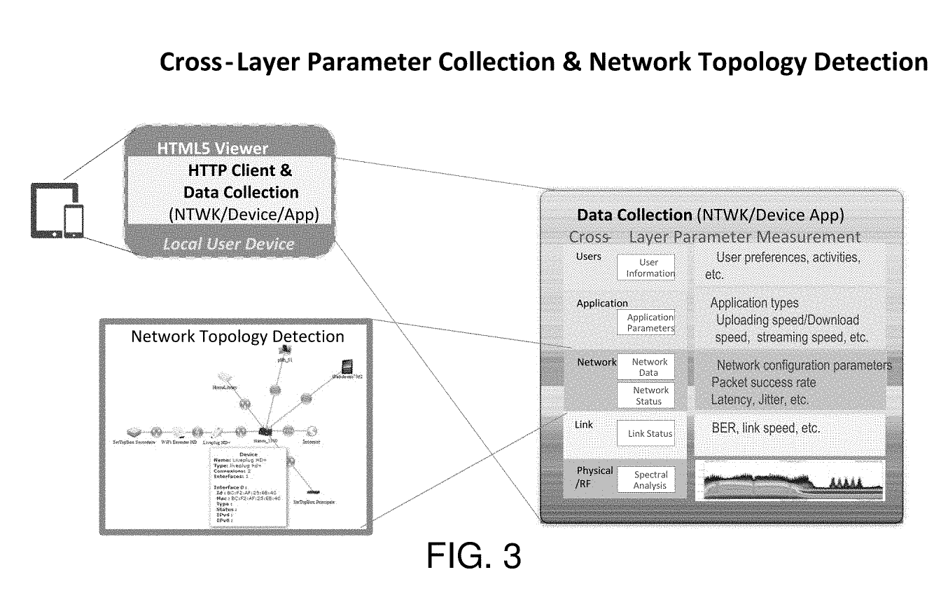

FIG. 3 is an illustration of one embodiment of a Cross-Layer Parameter Collection & Network Topology Detection system that may be used in the disclosed method and apparatus to collect data.

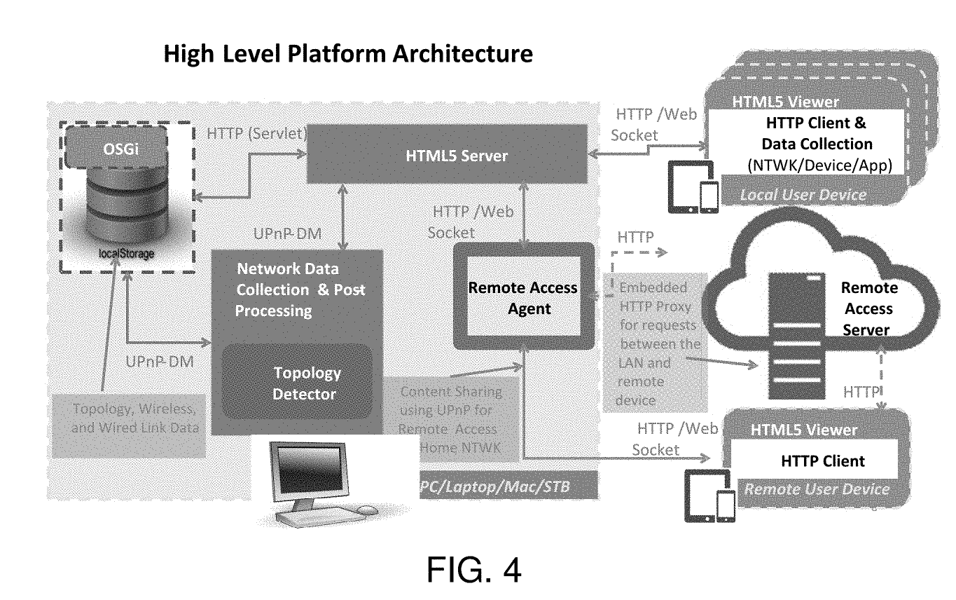

FIG. 4 is an illustration of a High Level Platform Architecture that can be used to implement the system of the disclosed method and apparatus.

Accordingly, the disclosed method and apparatus provides an architecture for a smart home or other environment that not only acts on commands received from a user, but also creates a natural and meaningful interaction between itself and the residents. The disclosed method and apparatus can enable real-time interaction of a “thinking structure” (such as a thinking home or thinking building) with its occupants. The disclosed system can analytically model the resident experience and response to it in real-time, to maximize an occupant's level of comfort.

A major contributor to creation of the thinking smart structure, such as a home or building, environment of the disclosed method and apparatus is the QoE model (which in some embodiments is a per-occupant, real-time, quality of experience) that is based on the existing context and some historical data. The QoE determines the user's level of comfort and satisfaction, and accordingly adjusts the control “knobs” to maximize it. For some industrial application, an interactive structure, such as a building, can provide the level of employee's performance, or giving advice, alerts or guidance depending on the type of task that is needed to be performed at occupant's location. In Enterprise, or home environments a deep-learning based QoE estimation model should be able to predict and furnish user satisfaction by processing the user related data along with the environmental data in a proactive way. In this regards definition of the relevant user data values that can be obtained proactively by observing and inferring from user behavior is very important.

The disclosed method and apparatus uses smart mobile devices equipped with a type of sensing mechanisms that can measure various user specific biological and interactive parameters, such as heart rate, body temperature, and facial expression (through post processing camera images on a smart phone) to identify and analyze data, in addition to environmental parameters such as the room temperature, the time, and the location. After scaling and pruning, these contextual sensed data can be directly applied to a machine learning-based user decision prediction and to a related QoE estimation module (e.g. deep learning) that is uses these contexts along with some historical user decision data to infer user preference leading to a decision for each smart home application scenario.

The result is a super intelligent structure, such as a home/building, that interacts with its occupants to enhance their comfort, security, health or job function based on ML algorithms. Algorithms for maximizing the user experience are determined based on a number of sensory mechanisms. The disclosed method and apparatus provides gateway level multi-access edge computing and can be combined with server-on demand using flying servers to the edge. Mapping a unique QoE for each user and determining his/her activity inside the home can result in various Smart Home Services that can enhance the occupants' experience and level of comfort.

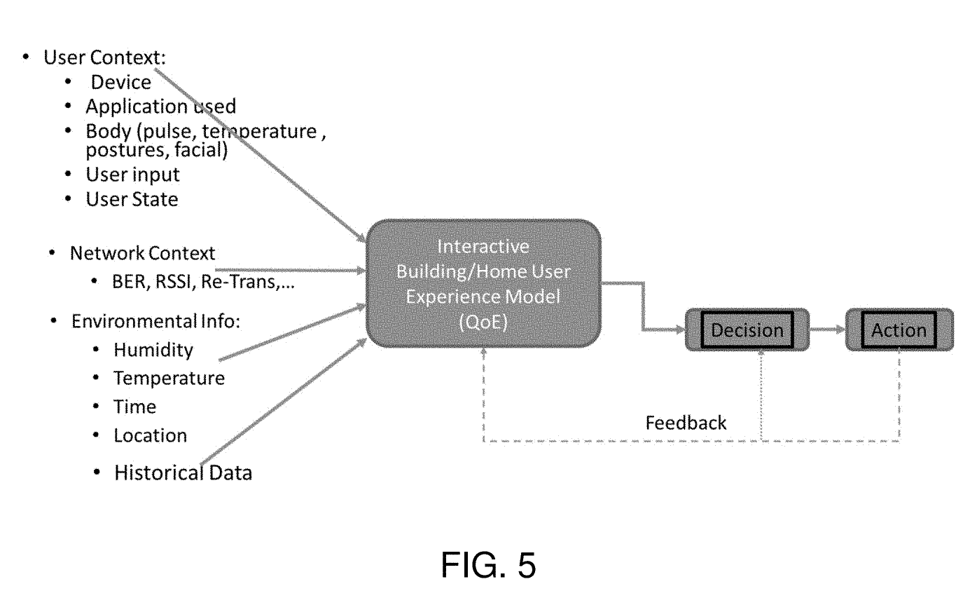

FIG. 5 is an illustration of the process flow for determining a QoE model.

### CONCLUSION

A number of embodiments of the disclosed method and apparatus have been described. It is to be understood that various modifications may be made without departing from the spirit and scope of the disclosed method and apparatus. For example, some of the steps described above may be order independent, and thus can be performed in an order different from that described. Further, some of the steps described above may be optional. Various activities described with respect to the methods identified above can be executed in repetitive, serial, or parallel fashion. It is to be understood that the foregoing description is intended to illustrate and not to limit the scope of the any claims that are presented in later filed applications that might claim priority to this disclosure. Accordingly, it should be understood that the invention is limited only by the claims as presented herein.

What is claimed is:

1. A next generation system for use in a “smart” structure, comprising:
(a) various sensors and devices configured to obtain data; and
(b) an analytical engine configured to determine a user's preferences and requirements.
